(19) United States
(12) Patent Application Publication
(10) Pub. No.: US 2026/0356536 A1
(43) Pub. Date: Nov. 12, 2026

(54) PAPER CONTAINER AND MANUFACTURING METHOD THEREFOR

(71) Applicant: Kai-Yu CHANG, Taichung (TW)

(72) Inventor: Ching-Wen CHANG, Miaoli County (TW)

(21) Appl. No.: 19/488,321

(22) PCT Filed: Jul. 6, 2023
(86) PCT No.: PCT/CN2023/106095

§ 371 Date: Nov. 26, 2025

(51) Int. Cl. B65D 5/42; A45C 11/20; B31B 50/14; B31B 110/10; B32B 1/00; B32B 3/26; B32B 27/10; B65D 3/06; B65D 3/28

(52) U.S. Cl. CPC B65D 5/425; A45C 11/20; B31B 50/142; B32B 1/00; B32B 3/266; B32B 27/10; B65D 3/06; B65D 3/28; B31B 2110/10; B32B 2250/02; B32B 2307/412; B32B 2307/7265; B32B 2439/00

(57) ABSTRACT

The present application relates to a paper container, including: a paper layer including at least one basic pattern area; at least one pattern unit arranged in the at least one basic pattern area, each pattern unit including hollowed-out structures and at least one reinforcing structure, and the at least one reinforcing structure being arranged between adjacent hollowed-out structures; and at least one waterproof light-transmissive layer that is arranged on at least one side of the paper layer and seals the hollowed-out structures, the hollowed-out structures and each waterproof light-transmissive layer being overlapped with each other in the thickness direction to form at least one window. A manufacturing method for the paper container is also provided. With the reinforcing structure, structures around the hollowed-out structures have high structural strength and are not prone to deforming under the action of external force.

### BACKGROUND OF THE INVENTION

### Field of the Invention

The present invention relates to a paper container and manufacturing method therefor, particularly to a technical structural improvement for a paper container configured to contain articles or liquids and to its manufacturing method.

### Description of the Prior Art

Generally, containers such as PET bottles, paper containers, and lunch boxes are mainly used for containing, for example, liquids or articles. Typically, during processing of a paper container, a through hole is formed to define a window 80 configured to allow a user to observe an internal structure of the paper container through the through hole.

As shown in FIG. 11, a paper container material 100 of the prior art includes a window hole 101 and a non-hollowed-out structure 102. The window hole 101 is formed as a continuously extending pattern and at least partially surrounds the non-hollowed-out structure 102. During manufacture of the window hole 101 of the paper container material 100, after forming the window hole, a pushing unit pushes waste separated inside the window hole 101 away from the window hole 101.

However, the non-hollowed-out structure 102 has only a single supporting portion 103, resulting in insufficient supporting strength. Thus, when the pushing unit pushes the waste, the non-hollowed-out structure 102 is driven to swingably move and twist deform relative to the single supporting portion 103, making it difficult to maintain an integral structure of the window hole 101 during manufacture. Meanwhile, during a laminating process of the paper container material 100, twisting deformation of the non-hollowed-out structure 102 also tends to cause poor quality.

The present invention is, therefore, arisen to obviate or at least mitigate the above-mentioned disadvantages.

### SUMMARY OF THE INVENTION

The main object of the present invention is to provide a paper container and manufacturing method therefor, which include a reinforcing structure so that structures around hollowed-out structures have high structural strength and are not easily deformed by external forces.

To achieve the above and other objects, a paper container is provided, wherein the paper container includes: a paper layer including at least one basic pattern area; at least one pattern unit disposed within the at least one basic pattern area, each of the at least one pattern unit including a plurality of hollowed-out structures and at least one reinforcing structure, the at least one reinforcing structure being disposed between adjacent ones of the plurality of hollowed-out structures and intersecting the adjacent ones of the plurality of hollowed-out structures; and at least one waterproof light-transmissive layer disposed on at least one side of the paper layer and sealing the plurality of hollowed-out structures, the plurality of hollowed-out structures and each of the at least one waterproof light-transmissive layer overlapping with each other in a thickness direction to form at least one window.

To achieve the above and other objects, a manufacturing method of a paper container is provided, wherein the manufacturing method includes following steps of: preparing a paper material defining at least one basic pattern area; providing a cutting unit including a cutting die; using the cutting die of the cutting unit to cut the paper material to form at least one pattern unit disposed within the at least one basic pattern area, each of the at least one pattern unit including a plurality of hollowed-out structures and at least one reinforcing structure, the at least one reinforcing structure being disposed between adjacent ones of the plurality of hollowed-out structures and intersecting the adjacent ones of the plurality of hollowed-out structures; and covering at least one side of the paper layer and sealing the plurality of hollowed-out structures with at least one waterproof light-transmissive layer;
wherein a shape of the cutting die corresponds to the plurality of hollowed-out structures.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a perspective view of a first exemplary embodiment of the present invention;

FIG. 2 is a cross-sectional view taken along line A-A of FIG. 1;

FIG. 3 is a cross-sectional view taken along line B-B of FIG. 1;

FIG. 4 is a partially enlarged view of the first exemplary embodiment of the present invention;

FIG. 5 is a perspective view of a second exemplary embodiment of the present invention;

FIG. 6 is a flow diagram of the first exemplary embodiment of the present invention;

FIG. 7 is a manufacturing flow diagram of the first exemplary embodiment of the present invention;

FIG. 8 is a schematic view of a paper container substrate in the first exemplary embodiment of the present invention;

FIG. 9 is a schematic view of a paper container package in the first exemplary embodiment of the present invention;

FIG. 10 is a schematic view of a cutting unit in the first exemplary embodiment of the present invention; and

FIG. 11 is a schematic view of a paper container material according to the prior art.

### DETAILED DESCRIPTION OF THE PREFERRED EMBODIMENTS

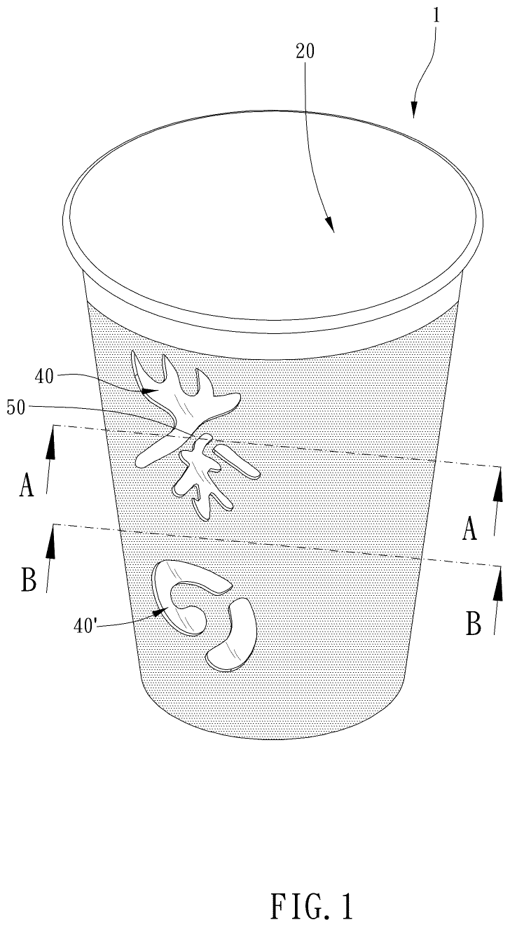

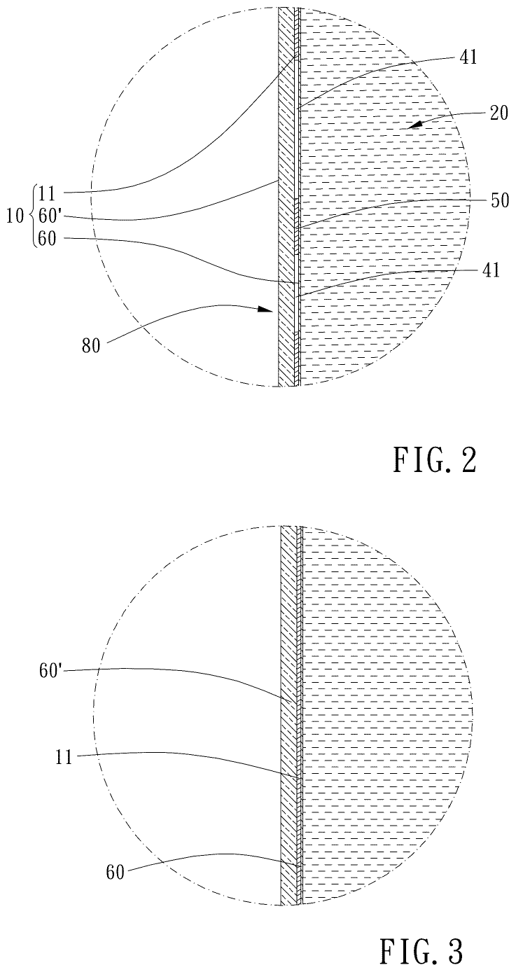

Please refer to FIGS. 1 to 4 for an exemplary embodiment of the present invention. A paper container 1 and manufacturing method therefor of the present invention includes a paper layer 11, at least one pattern unit 40, 40′, and at least one waterproof light-transmissive layer 60, 60′.

The paper layer 11 includes at least one basic pattern area 30, 30′. The at least one pattern unit 40, 40′ is disposed within the at least one basic pattern area 30, 30′. Each of the pattern units 40, 40′ includes a plurality of hollowed-out structures 41a, 41b, 41c, 41d, 41e and at least one reinforcing structure 50. The at least one reinforcing structure 50 is disposed between adjacent ones of the plurality of hollowed-out structures 41a, 41b, 41c, 41d, 41e and intersects the adjacent ones of the plurality of hollowed-out structures 41a, 41b, 41c, 41d, 41e. The at least one waterproof light-transmissive layer 60, 60′ is disposed on at least one side of the paper layer 11 and closes the plurality of hollowed-out structures 41a, 41b, 41c, 41d, 41e. The plurality of hollowed-out structures 41a, 41b, 41c, 41d, 41e and each of the waterproof light-transmissive layers 60, 60′ overlap with each other in a thickness direction to form at least one or a plurality of windows 80. By virtue of each reinforcing structure 50, each pattern unit 40, 40′ can maintain its integral shape. Specifically, each reinforcing structure 50 can inhibit portions adjacent to the plurality of hollowed-out structures 41a, 41b, 41c, 41d, 41e from deforming under force. Moreover, the interior of the paper container 1 can be observed through each window 80. The paper container 1 is configured to contain liquids and articles.

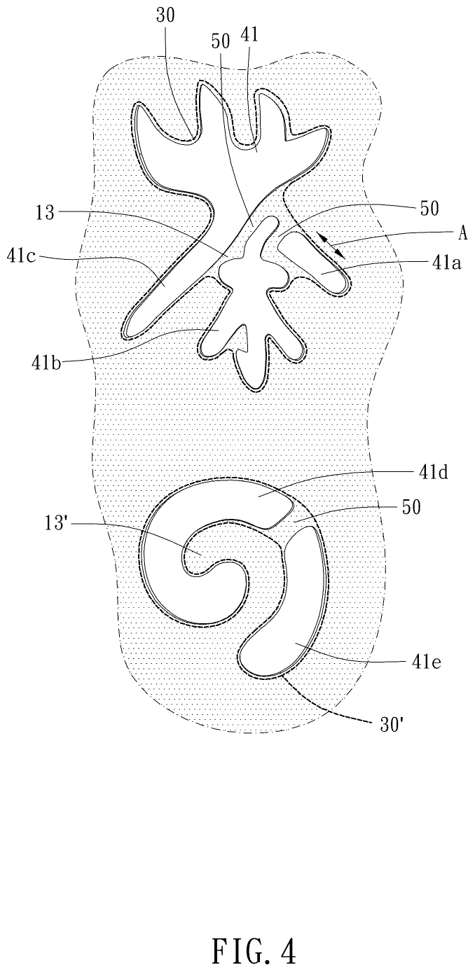

The at least one pattern unit 40, 40′ forms a character, and each of the basic pattern areas 30, 30′ has a shape corresponding to a shape of one of the pattern units 40, 40′. The character may be, for example, a Chinese character, a Japanese character, a Korean character, or other character, such as the Chinese character “ [symbol] ” and the Japanese character “ [symbol] ” shown in FIG. 4, but is not limited thereto. Each of the pattern units 40, 40′ may also be a design graphic or a pattern. Specifically, each of the hollowed-out structures 41a, 41b, 41c, 41d, 41e includes a stroke portion and/or a radical portion, and the plurality of hollowed-out structures 41a, 41b, 41c, 41d, 41e and each of the reinforcing structures 50 form the character. The stroke portion may correspond to the hollowed-out structure 41a, and the radical portion may correspond to the hollowed-out structures 41b, 41c, but is not limited thereto. Specifically, the basic pattern area 30′ may form a continuously extending stroke portion, such as forming the Japanese character “ [symbol] ”. The at least one reinforcing structure 50 intersects the continuously extending stroke portion so that the plurality of hollowed-out structures 41d, 41e form a non-continuously extending “ [symbol] ”. In addition, the at least one reinforcing structure 50 can also intersect adjacent radical portions, and between a radical portion and a stroke portion, but is not limited thereto. In this way, structural strength at locations adjacent to the plurality of hollowed-out structures is improved.

The paper layer 11 further includes a non-hollowed-out structure 13, 13′ within the at least one basic pattern area 30, 30′. The plurality of hollowed-out structures 41a, 41b, 41c, 41d, 41e surround the non-hollowed-out structure 13, 13′. At least two of the hollowed-out structures extend in a circumferential direction of the non-hollowed-out structure 13, 13′, such as the plurality of hollowed-out structures 41b, 41c extending in a circumferential direction of the non-hollowed-out structure 13, and the plurality of hollowed-out structures 41d, 41e extending in a circumferential direction of the non-hollowed-out structure 13′. The non-hollowed-out structure 13, 13′ is connected to the at least one reinforcing structure 50 so as to reinforce and support the non-hollowed-out structure 13, 13′ that originally has weaker supporting strength. Preferably, the at least one pattern unit includes a plurality of reinforcing structures 50, and the plurality of reinforcing structures 50 are connected to one another. By using the plurality of reinforcing structures 50, the plurality of pattern units 40, 40′ can maintain their integral shapes and surrounding structures are not easily deformed by external forces.

In an extension direction A of the at least one reinforcing structure 50, each of the hollowed-out structures 41a, 41b, 41c, 41d, 41e is larger than the at least one reinforcing structure 50, thereby maintaining integrity of the pattern units 40, 40′ and facilitating recognition of their originally designed shapes.

The paper layer 11 includes a plurality of the basic pattern areas 30, 30′, and the plurality of basic pattern areas 30, 30′ are spaced apart from one another. The at least one pattern unit includes a plurality of pattern units 40, 40′, and each of the pattern units 40, 40′ is disposed within one of the basic pattern areas 30, 30′. A spacing distance between two adjacent ones of the hollowed-out structures 41a, 41b, 41c, 41d, 41e in each of the pattern units 40, 40′ is smaller than a spacing distance between two adjacent ones of the basic pattern areas 30, 30′. Specifically, each of the pattern units 40, 40′ forms its own individual character, and in other embodiments may also form an individual graphic or pattern.

The at least one waterproof light-transmissive layer includes a plurality of waterproof light-transmissive layers 60, 60′, which are respectively disposed on opposite sides of the paper layer 11 and respectively seal opposite sides of the hollowed-out structures 41a, 41b, 41c, 41d, 41e, thereby providing waterproof and light-transmissive functions. Each of the waterproof light-transmissive layers 60, 60′ is a plastic coating layer laminated on the paper layer 11 to facilitate processing and to resist detachment. In other embodiments, each of the waterproof light-transmissive layers 60, 60′ may be bonded or adhered to the paper layer 11, or may be applied by spraying over the paper layer 11.

Each of the waterproof light-transmissive layers 60, 60′ may be made of polyethylene terephthalate PET, polyethylene PE, polystyrene PS, polylactic acid PLA, or any mixture of the foregoing materials. A plastic layer may be made of low-density polyethylene LDPE, high-density polyethylene HDPE, polypropylene PP, polyethylene PE, polylactic acid PLA, or any mixture of the foregoing materials.

Specifically, the paper container includes a wall 10 and a chamber 20. The wall 10 defines the chamber 20, and the wall 10 includes the paper layer 11 and the at least one waterproof light-transmissive layer 60, 60′.

In this embodiment, the paper container 1 is a cup body.

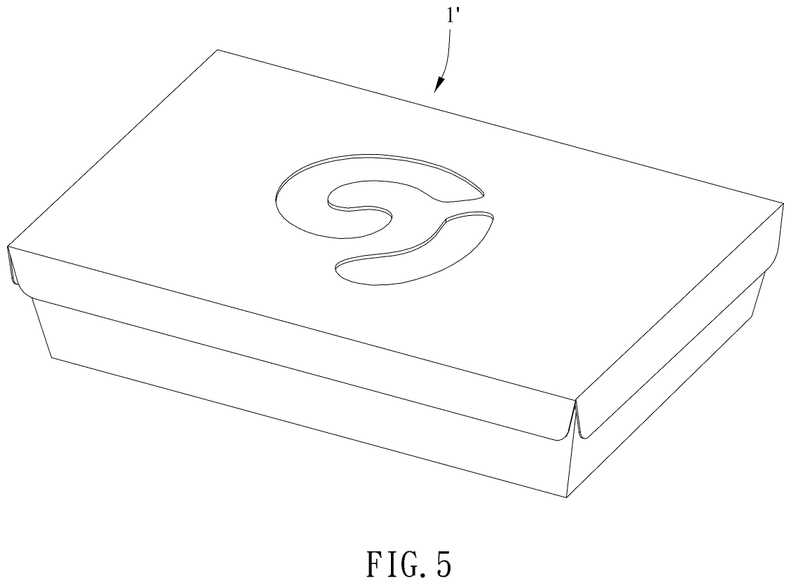

Please refer to FIG. 5, which illustrates a second exemplary embodiment of the present invention. A paper container 1′ is a box, such as a lunch box, but is not limited thereto.

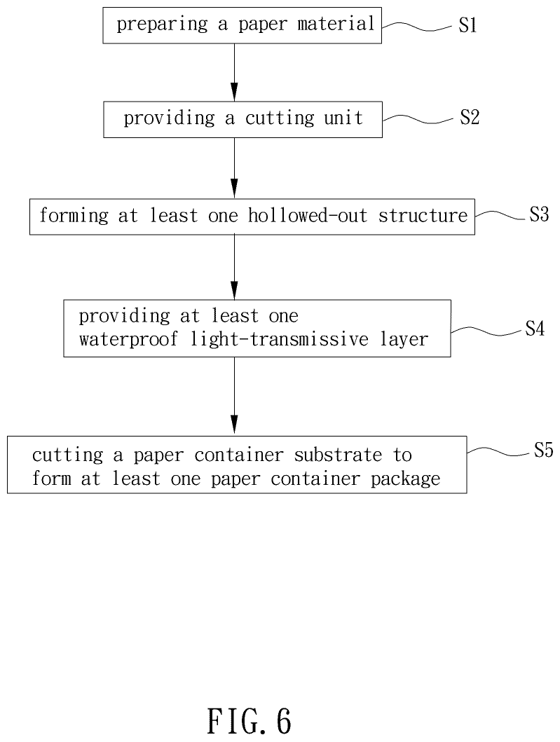

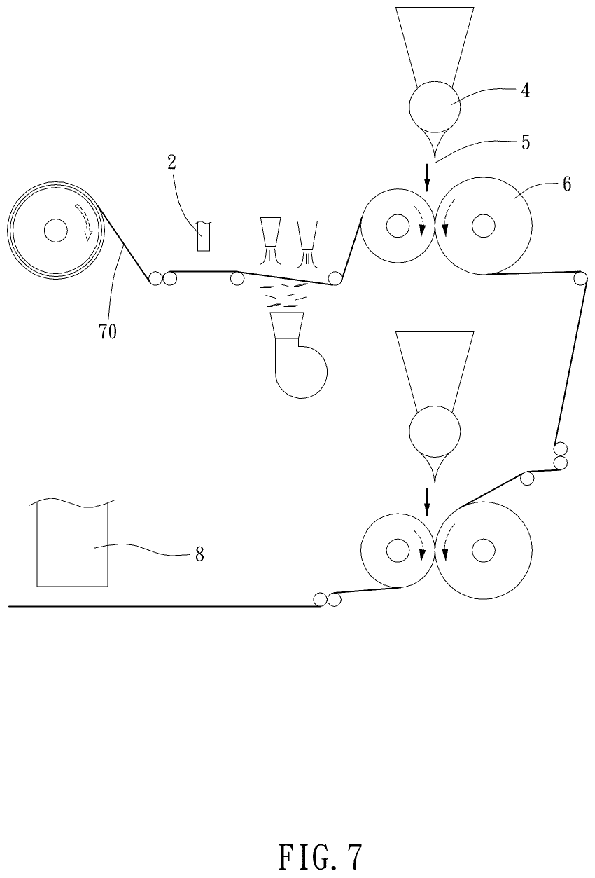

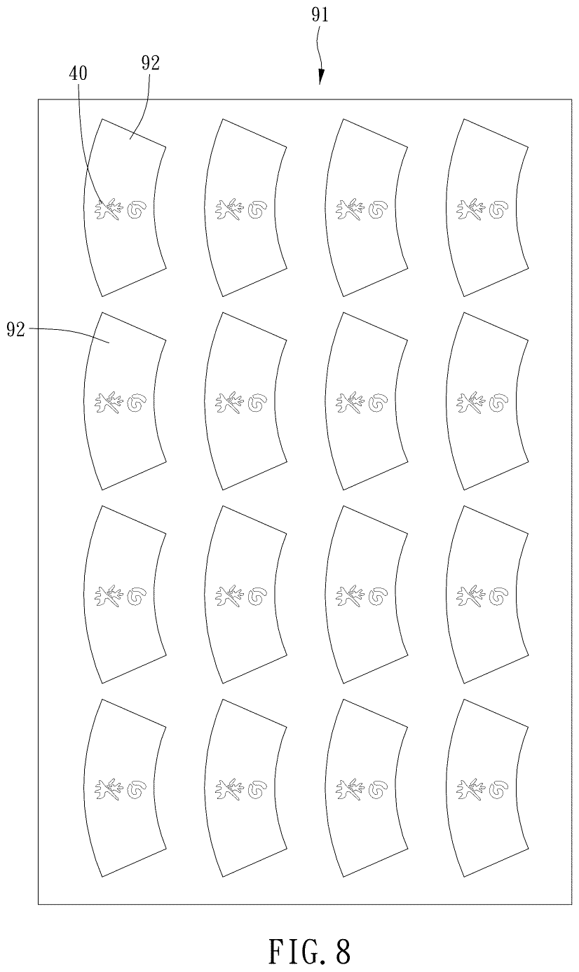

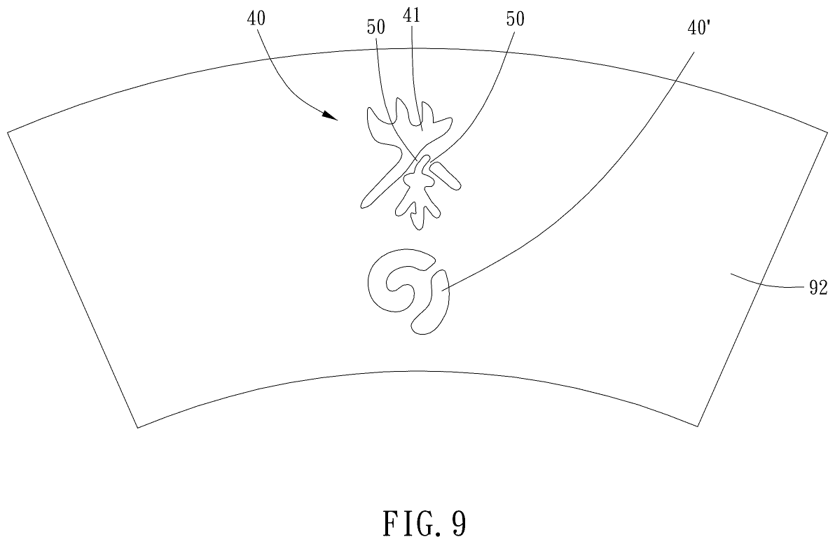

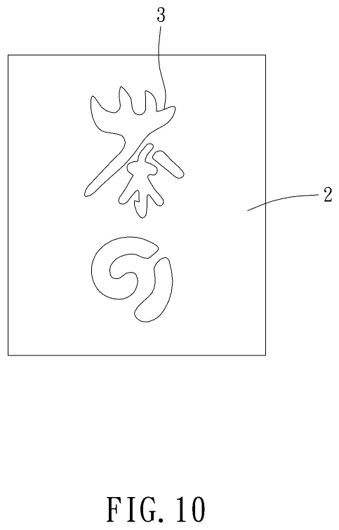

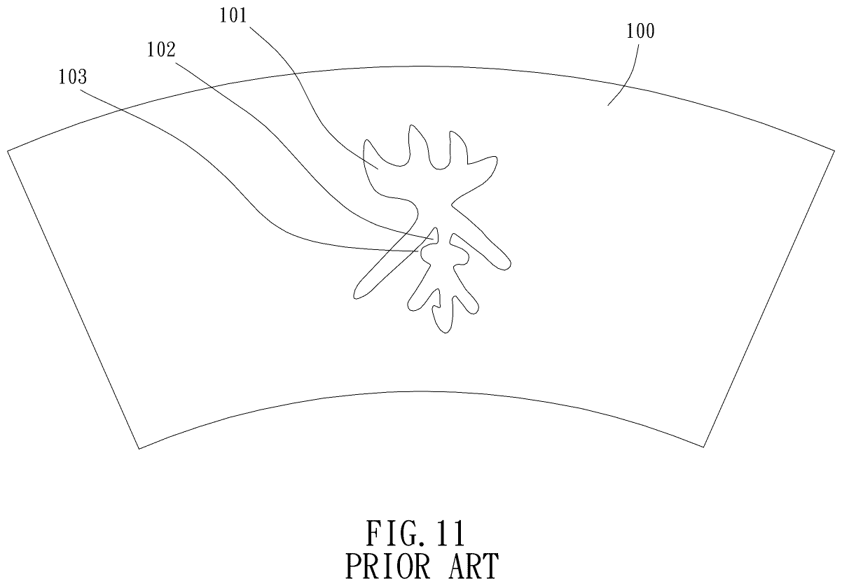

Please refer to FIGS. 6 to 10. The present invention further provides a manufacturing method of a paper container. The manufacturing method includes the following steps of: step S1: preparing a paper material 70, the paper material 70 defining at least one basic pattern area 30, 30′; step S2: providing a cutting unit 2, the cutting unit 2 including a cutting die 3; step S3: using the cutting die 3 of the cutting unit 2 to cut the paper material to form at least one pattern unit 40, 40′ disposed within the at least one basic pattern area 30, 30′, each of the pattern units 40, 40′ including a plurality of hollowed-out structures 41a, 41b, 41c, 41d, 41e and at least one reinforcing structure 50, the at least one reinforcing structure 50 being disposed between adjacent ones of the plurality of hollowed-out structures 41a, 41b, 41c, 41d, 41e and intersecting the adjacent ones of the plurality of hollowed-out structures 41a, 41b, 41c, 41d, 41e; step S4: covering at least one side of the paper layer 11 and closing the hollowed-out structures 41a, 41b, 41c, 41d, 41e, with at least one waterproof light-transmissive layer 60, 60′, to form a paper container substrate 91. Specifically, a film 5 is formed by heating and extruding with an extruder 4, and the film 5 serves as the waterproof light-transmissive layer 60, 60′ covering the paper material 70, followed by cooling and rolling with a roller 6; and step S5: cutting the paper container substrate 91 to form at least one or a plurality of paper container packages 92. The plurality of paper container packages 92 can form the paper container 1 as shown in FIG. 1, or can form the paper container in a box shape such as a lunch box, but is not limited thereto, or can form a bottle-shaped paper container. Specifically, a cutting machine 8 is used to cut the paper container substrate 91. The cutting die 3 has a shape corresponding to the hollowed-out structures 41a, 41b, 41c, 41d, 41e. Accordingly, the plurality of hollowed-out structures 41a, 41b, 41c, 41d, 41e are formed through simple steps, and portions surrounded by the hollowed-out structures 41a, 41b, 41c, 41d, 41e are not easily deformed by external forces during manufacture, thereby achieving high structural strength.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A paper container including:
a paper layer including at least one basic pattern area;
at least one pattern unit disposed within the at least one basic pattern area, each of the at least one pattern unit including a plurality of hollowed-out structures and at least one reinforcing structure, the at least one reinforcing structure being disposed between adjacent ones of the plurality of hollowed-out structures and intersecting the adjacent ones of the plurality of hollowed-out structures; and
at least one waterproof light-transmissive layer disposed on at least one side of the paper layer and sealing the plurality of hollowed-out structures, the plurality of hollowed-out structures and each of the at least one waterproof light-transmissive layer overlapping with each other in a thickness direction to form at least one window.

2. The paper container of claim 1, wherein the at least one pattern unit forms a character, and each of the at least one basic pattern area has a shape corresponding to a shape of one of the at least one pattern unit.

3. The paper container of claim 2, wherein each of the plurality of hollowed-out structures includes a stroke portion or a radical portion, and the plurality of hollowed-out structures and each of the at least one reinforcing structure form the character.

4. The paper container of claim 1, wherein the paper layer further includes a non-hollowed-out structure within the at least one basic pattern area, the plurality of hollowed-out structures surround the non-hollowed-out structure, at least two of the plurality of hollowed-out structures extend in a circumferential direction of the non-hollowed-out structure, and the non-hollowed-out structure is connected to the at least one reinforcing structure.

5. The paper container of claim 1, wherein the at least one reinforcing structure includes a plurality of reinforcing structures, and the plurality of reinforcing structures are connected to one another.

6. The paper container of claim 1, wherein in an extension direction of the at least one reinforcing structure, each of the plurality of hollowed-out structures is larger than the at least one reinforcing structure.

7. The paper container of claim 1, wherein the at least one waterproof light-transmissive layer includes a plurality of the waterproof light-transmissive layers respectively disposed on opposite sides of the paper layer and respectively seal opposite sides of the plurality of hollowed-out structures.

8. The paper container of claim 1, further including a wall and a chamber, wherein the wall defines the chamber, and the wall includes the paper layer and the at least one waterproof light-transmissive layer.

9. The paper container of claim 3, wherein the at least one basic pattern area includes a plurality of basic pattern areas spaced apart from one another; the at least one pattern unit includes a plurality of pattern units, and each of the plurality of pattern units is disposed within one of the plurality of basic pattern areas; a spacing distance between two adjacent ones of the plurality of hollowed-out structures in each of the plurality of pattern units is smaller than a spacing distance between two adjacent ones of the plurality of basic pattern areas; the paper layer further includes a non-hollowed-out structure within the at least one basic pattern area, the plurality of hollowed-out structures surround the non-hollowed-out structure, at least two of the plurality of hollowed-out structures extend in a circumferential direction of the non-hollowed-out structure, and the non-hollowed-out structure is connected to the at least one reinforcing structure; each of the plurality of pattern units includes a plurality of reinforcing structures, and the plurality of reinforcing structures are connected to one another; in an extension direction of the at least one reinforcing structure, each of the plurality of hollowed-out structures is larger than the at least one reinforcing structure; the at least one waterproof light-transmissive layer includes a plurality of the waterproof light-transmissive layers respectively disposed on opposite sides of the paper layer and respectively seal opposite sides of the plurality of hollowed-out structures; and each of the plurality of waterproof light-transmissive layers is a plastic coating layer laminated on the paper layer.

10. A manufacturing method of a paper container includes following steps of:
preparing a paper material defining at least one basic pattern area;
providing a cutting unit including a cutting die;
using the cutting die of the cutting unit to cut the paper material to form at least one pattern unit disposed within the at least one basic pattern area, each of the at least one pattern unit including a plurality of hollowed-out structures and at least one reinforcing structure, the at least one reinforcing structure being disposed between adjacent ones of the plurality of hollowed-out structures and intersecting the adjacent ones of the plurality of hollowed-out structures; and
covering at least one side of the paper layer and sealing the plurality of hollowed-out structures with at least one waterproof light-transmissive layer;
wherein a shape of the cutting die corresponds to the plurality of hollowed-out structures.
